(19) United States
(12) Patent Application Publication
(10) Pub. No.: US 2022/0363794 A1
(43) Pub. Date: Nov. 17, 2022

(54) POLYMERS FOR PRESSURE-SENSITIVE ADHESIVES WITH ANTISTATIC PROPERTIES

(71) Applicant: 3M INNOVATIVE PROPERTIES COMPANY, St. Paul, MN (US)

(72) Inventors: Hae-Seung Harry Lee, Woodbury, MN (US); Youhoon Kim, Woodbury, MN (US)

(21) Appl. No.: 17/621,173

(22) PCT Filed: Jun. 15, 2020
(86) PCT No.: PCT/IB2020/055583

§ 371 Date: Dec. 20, 2021

Related U.S. Application Data
(60) Provisional application No. 62/864,904, filed on Jun. 21, 2019.

(51) Int. Cl. C08F 220/18; C09J 133/08

(52) U.S. Cl. CPC C08F 220/1808; C09J 133/08

(57) ABSTRACT

Antistatic polymers including divalent segments represented by formula a) wherein R¹ represents hydrogen or methyl, R² represents an alkylene group having from 1 to 10 carbon atoms, R³ and R⁴ independently represent alkyl groups having from 1 to 4 carbon atoms, and X represents a halogen. Methods of making antistatic polymers and uses thereof as PSAs are also disclosed. a)

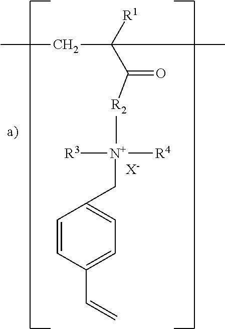

### TECHNICAL FIELD

The present disclosure broadly relates to antistatic polymers for use in pressure-sensitive adhesives and methods of making them.

### BACKGROUND

Electrostatic charge buildup is responsible for a variety of problems in the processing and the use of many industrial products and materials. For example, electrostatic charging can cause materials to stick together or to repel one another. In addition, static charge buildup can cause objects to attract dirt and dust that can lead to fabrication or soiling problems and can impair product performance. Sudden electrostatic discharges from insulating objects can also be a serious problem. When flammable materials are present, a static electric discharge can serve as an ignition source, resulting in fires and/or explosions.

Electrostatic charge can be a problem in the electronics industry, because modern electronic devices are extremely susceptible to permanent damage by electrostatic discharges. The buildup of electrostatic charge on insulating objects is especially common and problematic under conditions of low humidity and when liquids or solids move in contact with one another.

Static charge build-up can be controlled by increasing the electrical conductivity of a material. This can be accomplished by increasing ionic or electronic conductivity. Most antistatic agents operate by dissipating static charge as it builds up. Because low surface resistivity implies high surface conductivity, a material with low surface resistivity can discharge static charges away through its surface. Thus, a material's surface resistivity is one measure of the effectiveness of antistatic agents.

### SUMMARY

Polymeric materials for use in pressure sensitive adhesive (“PSA”) applications are disclosed. The disclosed materials have pendant unsaturation functional groups along the main polymer backbone via a quaternary ammonium salt formation. When PSA tapes including the materials are applied on adherends, the pendant unsaturation can be further crosslinked by typical UV radical generators, resulting in lower adhesion of the PSA to the adherend. The irradiated PSAs can then be easily removed from the adherends without damaging the adherend surfaces. Due to the existence of the ammonium salts in the polymer system, the developed PSAs possess low surface resistivity as well as anti-static properties which may be beneficial for electronic applications.

Provided in one aspect are antistatic polymers comprising:
divalent segments a) represented by the formula

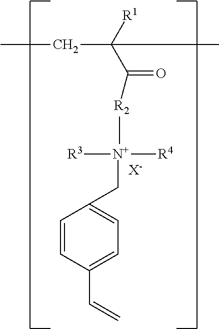

wherein
R¹ represents hydrogen or methyl,
R² represents an alkylene group having from 1 to 10 carbon atoms, inclusive,
R³ and R⁴ independently represent alkyl groups having from 1 to 4 carbon atoms, inclusive, and
X represents a halogen.

Provided in another aspect is a method of making an antistatic polymer, the method comprising:
reacting a first (meth)acrylate with a second (meth)acrylate to provide a first polymer, the first polymer including divalent segments b) represented by the formula

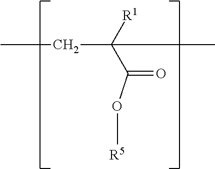

wherein
R¹ represents hydrogen or methyl, and
R⁵ represents an alkylene group having from 4 to 18 carbon atoms, inclusive, and divalent segments c) represented by the formula

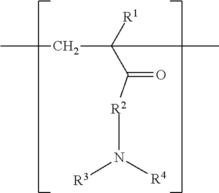

wherein
R¹ represents hydrogen or methyl,
R² represents an alkylene group having from 1 to 10 carbon atoms, inclusive, and
R³ and R⁴ independently represent alkyl groups having from 1 to 4 carbon atoms, inclusive; and
adding an initiator to the first polymer; and
reacting the first polymer with 4-(chloromethyl) styrene to provide the antistatic polymer, the antistatic polymer comprising divalent segments a) represented by the formula

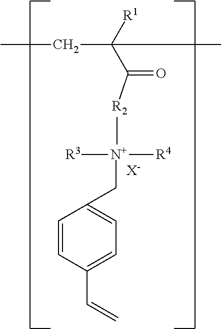

wherein
R¹ represents hydrogen or methyl,
R² represents an alkylene group having from 1 to 10 carbon atoms, inclusive,
R³ and R⁴ independently represent alkyl groups having from 1 to 4 carbon atoms, inclusive, and
X represents a chlorine.

As used herein:

The term “alkyl” refers to a monovalent group that is a radical of an alkane, which is a saturated hydrocarbon. The alkyl can be linear, branched, cyclic, or combinations thereof and typically has 1 to 20 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof. The alkylene typically has 1 to 20 carbon atoms. The radical centers of the alkylene can be on the same carbon atom (i.e., an alkylidene) or on different carbon atoms.

The term “(meth)acrylate” or “(meth)acrylic acid” is used herein to denote the corresponding acrylate and methacrylate. Thus, for instance, the term “(meth)acrylic acid” covers both methacrylic acid and acrylic acid, and the term “(meth)acrylate” covers both acrylates and methacrylates. The (meth)acrylate or the (meth)acrylic acid may consist only of the methacrylate or methacrylic acid, respectively, or may consist only of the acrylate or the acrylic acid, respectively, yet may also relate to a mixture of the respective acrylate and methacrylate (or acrylic acid and methacrylic acid).

As used herein, the term “and/or” is used to indicate one or both stated cases may occur, for example A and/or B includes, (A and B) and (A or B).

As used herein, the term “room temperature” refers to a temperature in the range of 20° C. to 25° C.

Features and advantages of the present disclosure will be further understood upon consideration of the detailed description as well as the appended claims.

### DETAILED DESCRIPTION

The physicochemical properties (e.g., adhesion, cohesion, wettability, tackiness) of pressure sensitive adhesives (“PSAs”) depend on various factors, such as the degree of crosslinking. Once created in a PSA system, the crosslinked polymeric network inhibits the mobility of the polymer matrix and can affect various properties of the PSA. For example, it is generally accepted that an increase in crosslinking density, up to a certain level, can improve both adhesion and cohesion of a PSA, but at the expense of the PSA's tackiness. Thus, once the degree of crosslinking goes beyond a certain level, the PSA system loses both adhesion and tackiness, which may not be desirable for adhesive applications.

PSAs including polymers of the present disclosure may have characteristics similar to those of conventional dicing tapes. For example, they can be applied on various substrates (e.g., semiconductor materials) with good adhesion properties. When the disclosed PSA tapes are irradiated with UV light in the presence of UV radical generators, the unsaturation groups on the main polymer backbone undergo a typical radical polymerization process that results in increased crosslinking density in the polymer system. As a result of the increased crosslinking density, the adhesion of the PSA tapes toward the substrates is dramatically reduced and the PSA tapes can be easily removed, like conventional dicing tapes. In addition to the described easy-removal function, this newly developed polymer system has several advantages over conventional dicing tapes.

For example, due to the existence of the quaternary ammonium salt on the polymer backbone, PSAs including the disclosed polymers possess low surface resistivity, which is beneficial for electronic applications. In general, when PSAs are detached from liners, high-voltage static electricity may be generated on the PSA surface. This static electricity attracts dust and is not good for sensitive electronic components. For this reason, it is desirable for PSAs used with electronic devices to have low surface resistivity so quickly discharge the static electricity. Unlike PSAs of the present disclosure, most PSAs don't have the ability to discharge electricity. Thus, anti-static function, if desired, must be added after PSA production, resulting in increased manufacturing costs.

Another advantage of polymers of the present disclosure is that their production does not require the use of hazardous catalysts to achieve coupling of the pendant group to the polymer backbone. Conventional dicing tape preparation typically involves a post-polymerization modification step involving the hydroxyl group from a HEMA monomer and the isocyanate group from an ICEMA monomer. Many times, this reaction requires a Sn-based catalyst to facilitate the coupling reaction at relatively mild conditions (e.g., <80° C.). The coupling reaction of the present disclosure (i.e., quaternary ammonium salt formation) does not require the use of a catalyst and is readily achievable at moderate reaction conditions (e.g., ≤65° C.).

Another advantage of polymers of the present disclosure is provided by the presence of the ammonium salt. It is known that ionic functional groups along the polymer backbone can lead to ionic interactions between polymer chains. As a result, aggregated ionic clusters may act as ionic crosslinkers which can improve the cohesive strength of the polymer system. Conventional dicing tapes lack ammonium salts and thus their associated benefits.

Another advantage of PSA tapes including polymers of the present disclosure is that crosslinking may be initiated not only by UV radical generators, (e.g., a mono- or bis-acylphosphine oxide, an hydroxyacetophenone, a benzophenone), but also by UV cationic initiators (e.g., triarylsulfonium salts), also known as photo-acid generators (“PAGs”). The grafted unsaturation disclosed herein is a styrenic group, which can be polymerized by radical, cationic, and anionic routes. When the cationic route is adopted for the crosslinking, the curing step is not affected by oxygen in the atmosphere, a condition which is problematic for current dicing tape technology.

### Antistatic Polymers

Provided herein are novel polymeric materials including pendant unsaturation moieties, the pendant unsaturation moieties added via quaternary ammonium salt formation. Antistatic polymers of the present disclosure comprise divalent segments a) represented by the formula

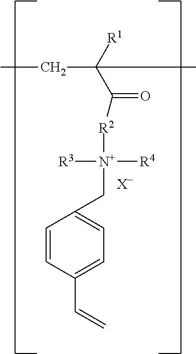

R¹ represents hydrogen or methyl.

R² represents an alkylene group having from 1 to 10 carbon atoms. Examples include methyl, ethyl, propyl, butyl, pentyl, hexyl, cyclohexyl, heptyl, octyl, isooctyl, nonyl, and decyl groups. In some embodiments R² is an ethyl group.

R³ and R⁴ independently represent alkyl groups having from 1 to 4 carbon atoms. Examples include methyl, ethyl, propyl, and butyl groups. In some embodiments R³ and R⁴ are methyl groups.

X represents a halogen (e.g., Cl).

In some embodiments, antistatic polymers of the present disclosure comprise divalent segments b) represented by the formula

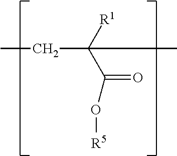

R¹ represents hydrogen or methyl.

R⁵ represents an alkylene group having from 4 to 18 carbon atoms. Examples include butyl, pentyl, hexyl, cyclohexyl, heptyl, octyl, isooctyl, nonyl, decyl, dodecyl, hexadecyl, and octadecyl groups. In some embodiments R⁵ has 8 carbon atoms.

In some embodiments, antistatic polymers of the present disclosure comprise divalent segments c) represented by the formula

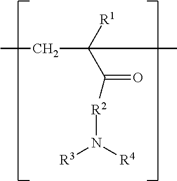

R¹ represents hydrogen or methyl.

R² represents an alkylene group having from 1 to 10 carbon atoms. Examples include methyl, ethyl, propyl, butyl, pentyl, hexyl, cyclohexyl, heptyl, octyl, isooctyl, nonyl, and decyl groups. In some embodiments R² is an ethyl group.

R³ and R⁴ independently represent alkyl groups having from 1 to 4 carbon atoms. Examples include methyl, ethyl, propyl, and butyl groups. In some embodiments R³ and R⁴ are methyl groups.

Although written in a left-to right orientation, it will be recognized that divalent segments a), b), and c) may equally be written in the opposite right-to-left orientation as incorporated into the polymer.

In some embodiments antistatic polymers of the present disclosure have a ratio of divalent segment a) to the sum of divalent segments b) and c) on a molar basis of from 17:1 to 2.5:1, 16.5:1 to 3:1, or 16.5:1 to 4:1 (e.g., 16.2:1 to 3.4:1).

In some embodiments antistatic polymers of the present disclosure have a ratio of divalent segment a) to divalent segment c) of at least 1:1, at least 1.5:1, at least 2.3:1, at least 4:1, at least 9:1, at least 19:1, at least 32:1, at least 49:1, or at least 99:1 (e.g., 66:1).

### PSAs

Antistatic polymers of the present disclosure may perform well as pressure-sensitive adhesives (“PSAs”) with desirable adhesion and sheer strength characteristics on a variety of substrates, such as, for example, metals (e.g., stainless steel), glasses, and ceramics.

Antistatic polymers of the present disclosure are curable, due at least in part to the presence of styrene moieties. In preferred embodiments, antistatic polymers of the present disclosure are curable, for example, by heating and/or exposure to light, such that after curing at least one characteristic of the antistatic polymer, such as, for example, adhesion or sheer strength, changes significantly.

In some embodiments, the PSAs including antistatic polymers of the present disclosure may also comprise at least one photoinitiator, meaning that the initiator is activated by light, generally ultraviolet (“UV”) light, although other light sources could be used with the appropriate choice of initiator, such a visible-light initiator, infrared-light initiators, and the like. Typically, UV photoinitiators are used.

Useful photoinitiators include those known as useful for photocuring free-radically polyfunctional (meth)acrylates. Exemplary photoinitiators include benzoin and its derivatives such as alpha-methylbenzoin; alpha-phenylbenzoin; alpha-allylbenzoin; alpha benzylbenzoin; benzoin ethers such as benzil dimethyl ketal (e.g., “OMNIRAD BDK” from IGM Resins USA Inc., St. Charles, Ill.), benzoin methyl ether, benzoin ethyl ether, benzoin n-butyl ether; acetophenone and its derivatives such as 2-hydroxy-2-methyl-1-phenyl-1-propanone (e.g., available under the trade designation OMNIRAD 1173 from IGM Resins USA Inc., St. Charles, Ill.) and 1-hydroxycyclohexyl phenyl ketone (e.g., available under the trade designation OMNIRAD 184 from IGM Resins USA Inc., St. Charles, IL); 2-methyl-1-[4-(methylthio)phenyl]-2-(4-morpholinyl)-1-propanone (e.g., available under the trade designation OMNIRAD 907 from IGM Resins USA Inc., St. Charles, Ill.); 2-benzyl-2-(dimethylamino)-1-[4-(4-morpholinyl)phenyl]-1-butanone (e.g., available under the trade designation OMNIRAD 369 from IGM Resins USA Inc., St. Charles, Ill.) and phosphine oxide derivatives such as ethyl-2,4,6-trimethylbenzoylphenyl phoshinate (e.g. available under the trade designation TPO-L from IGM Resins USA Inc., St. Charles, Ill.), and bis-(2,4,6-trimethylbenzoyl)-phenylphosphine oxide (e.g., available under the trade designation OMNIRAD 819 from IGM Resins USA Inc., St. Charles, Ill.)

UV cationic initiators, also known as photo-acid generators (“PAGs”) may be useful when polymerization by a cationic route is preferred. An exemplary PAG useful in embodiments of the present disclosure is a triarylsulfonium salt such as, for example, thiophenoxyphenyl) diphenylsulfonium hexafluorophosphate available from Gelest Inc. (Morrisville, Pa.). Other useful PAGs may include, for example, diarylhalonium salts and nitrobenzyl esters.

Other useful photoinitiators include, for example, pivaloin ethyl ether, anisoin ethyl ether, anthraquinones (e.g., anthraquinone, 2-ethylanthraquinone, 1-chloroanthraquinone, 1,4-dimethylanthraquinone, 1-methoxyanthraquinone, or benzanthraquinone), halomethyltriazines, benzophenone and its derivatives, iodonium salts and sulfonium salts, titanium complexes such as bis(eta5-2,4-cyclopentadien-1-yl)-bis[2,6-difluoro-3-(1H-pyrrol-1-yl) phenyl]titanium (e.g., available under the trade designation CGI 784DC from BASF, Florham Park, N.J.); halomethyl-nitrobenzenes (e.g., 4-bromomethylnitrobenzene), and combinations of photoinitiators where one component is a mono- or bis-acylphosphine oxide (e.g., available under the trade designations IRGACURE 651, IRGACURE 1700, IRGACURE 1800, and IRGACURE 1850 from BASF, Florham Park, N.J., and under the trade designation OMNIRAD 4265 from IGM Resins USA Inc., St. Charles, Ill.).

Generally, the photoinitiator if present is used in amounts of 0.01 to 5 parts by weight, more typically 0.02 to 2.0 parts by weight relative to 100 parts by weight of total reactive components in the PSA.

PSAs including antistatic polymers of the present disclosure may optionally contain one or more conventional additives. Additives may include, for example, tackifiers, plasticizers, dyes, pigments, antioxidants, UV stabilizers, corrosion inhibitors, dispersing agents, wetting agents, adhesion promotors, and fillers.

In some embodiments, PSAs including antistatic polymers of the present disclosure may have adhesion to a substrate of at least 1 oz/inch, at least 2 oz/inch, at least 3 oz/inch, at least 4 oz/inch, 5 oz/inch, at least 6 oz/inch, at least 7 oz/inch, or at least 8 oz/inch as measured according to ASTM

International standard, D3330, Method F. In some embodiments these PSAs may also exhibit sheer strength of less than 3000 minutes, less than 1500 minutes, less than 750 minutes, less than 500 minutes, less than 250 minutes, or less than 100 minutes as measured according to ASTM International standard, D3654, Procedure A at 23° C./50% RH (relative humidity) using a 500 g load.

In general, a material's low surface resistivity (high surface conductivity) implies that the material can discharge static charges away through its surface. Typical surface resistivity ranges for various materials are shown in Table 1.

TABLE 1
Surface Resistivity Ranges for Various Materials

| Material | Surface Resistivity (Ω/□) |
|---|---|
| Metals | E-5~E-4 |
| Carbon Powders & Fibers | E-3~E-1 |
| Shielding Composites | 1~E+2 |
| Conductive Composites | E+3~E+6 |
| Static Dissipative Composites | E+7~E+9 |
| Anti-Static Composites | E+10~E+12 |
| Typical Polymers | E+13~E+16 |

In some embodiments, PSAs including antistatic polymers of the present disclosure may exhibit Surface Resistivity measured according to the ASTM D257-07 protocol of less than 1×10¹⁴Ω/□, less than 1×10¹³Ω/□, or less than 1×10¹²Ω/□. In some embodiments, PSAs including antistatic polymers of the present disclosure may have utility in anti-static applications.

In preferred embodiments, PSAs including antistatic polymers of the present disclosure showed lower adhesion to a substrate after exposure to ultra-violet light. In some embodiments, adhesion in oz/inch after UV irradiation is less than 50%, less than 40%, less than 30%, less than 20%, or less than 10% of the adhesion in oz/inch before UV irradiation as measured according to ASTM International standard, D3330, Method F. In some embodiments these PSAs may also exhibit sheer strength of greater than 10000 minutes after UV irradiation as measured according to ASTM International standard, D3654, Procedure A at 23° C./50% RH (relative humidity) using a 500 g load.

Antistatic polymers of the present disclosure may be prepared according to methods known to those of ordinary skill in the relevant arts. For example, the antistatic polymers may be prepared by copolymerizing typical alkyl (meth)acrylates (e.g., isooctyl acrylate, 2-ethylhexyl acrylate) and tertiary amine-containing monomers (e.g., N,N,-dimethylaminoethyl methacrylate) in molar ratios as disclosed above in a suitable solvent, such as, for example, isopropyl alcohol,l to provide an intermediate polymer. The amino functional groups of the intermediate polymer may be further reacted with a halogen-containing unsaturated compound (e.g., 4-(chloromethyl)styrene) in a post-polymerization modification step, i.e., quaternary ammonium salt formation between a tertiary amine and haloalkyl compound. In some embodiments, it may be desirable to convert at least 50%, at least 60%, at least 70%, at least 80%, at least 90%, at least 95%, at least 98%, or at least 99% of the amino functional groups of the intermediate polymer to a quaternary ammonium salt in the post-polymerization modification step. The coupling reaction of the present disclosure (i.e., quaternary ammonium salt formation) does not require the use of a catalyst and is readily achievable at moderate reaction conditions (e.g., <65° C.).

In embodiments where a photo initiator is added to the PSA including antistatic polymers of the present disclosure, the initiator may be added to the intermediate polymer mixture before, after, or simultaneously with the addition of the halogen-containing unsaturated compound.

Antistatic polymers of the present disclosure may by particularly useful in adhesive tapes (e.g., PSA-coated tape) intended for application to surfaces of delicate electronic devices. For example, during transportation the PSA tapes can hold parts securely in place (i.e., create a bonded article) to prevent damage, but upon arrival at a final destination the tape can be easily removed by exposing the tape to an external stimulus (e.g., UV light, heat) and thereby reducing adhesion.

### SELECT EMBODIMENTS OF THE PRESENT DISCLOSURE

In a first embodiment, the present disclosure provides an antistatic polymer comprising:
divalent segments a) represented by the formula

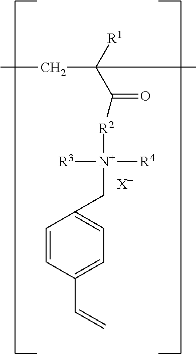

wherein
R¹ represents hydrogen or methyl,
R² represents an alkylene group having from 1 to 10 carbon atoms, inclusive,
R³ and R⁴ independently represent alkyl groups having from 1 to 4 carbon atoms, inclusive, and
X represents a halogen.

In a second embodiment, the present disclosure provides an antistatic polymer according to the first embodiment, further comprising divalent segments b) represented by the formula

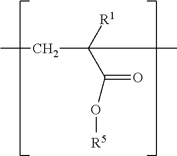

wherein
R¹ represents hydrogen or methyl, and
R⁵ represents an alkylene group having from 4 to 18 carbon atoms, inclusive.

In a third embodiment, the present disclosure provides an antistatic polymer according to the first or second embodiment, further comprising divalent segments c) represented by the formula

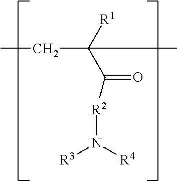

wherein
R¹ represents hydrogen or methyl,
R² represents an alkylene group having from 1 to 10 carbon atoms, inclusive, and
R³ and R⁴ independently represent alkyl groups having from 1 to 4 carbon atoms, inclusive.

In a fourth embodiment, the present disclosure provides an antistatic polymer according to any one of the first to third embodiments, wherein R² represents an alkylene group having 2 carbon atoms.

In a fifth embodiment, the present disclosure provides an antistatic polymer according to any one of the first to fourth embodiments, wherein R³ and R⁴ represent methyl.

In a sixth embodiment, the present disclosure provides an antistatic polymer according to any one of the second to fifth embodiments, wherein R⁵ represents an alkylene group having 8 carbon atoms.

In a seventh embodiment, the present disclosure provides an antistatic polymer according to any one of the third to sixth embodiments, wherein on a molar basis the ratio of divalent segment a) to the sum of divalent segments b) and c) is from 17:1 to 2.5:1, 17:1 to 3:1, or 16:1 to 4:1.

In an eighth embodiment, the present disclosure provides an antistatic polymer according to any one of the third to seventh embodiments, wherein on a molar basis the ratio of divalent segment a) to divalent segment c) is at least 1:1, at least 1.5:1, at least 2.3:1, at least 4:1, at least 9:1, at least 19:1, at least 32:1, at least 49:1, or at least 99:1.

In a ninth embodiment, the present disclosure provides an antistatic polymer according to any one of the first to seventh embodiments, wherein the antistatic polymer has a Surface Resistivity of less than 1×10¹⁴Ω/□.

In a tenth embodiment, the present disclosure provides an antistatic polymer according to any one of the first to ninth embodiments, wherein the antistatic polymer exhibits lower adhesion to a surface after exposure to ultra-violet light.

In an eleventh embodiment, the present disclosure provides an antistatic polymer according to any one of the first to tenth embodiments, wherein the antistatic polymer is a pressure-sensitive adhesive.

In a twelfth embodiment, the present disclosure provides an adhesive tape comprising the pressure-sensitive adhesive of the eleventh embodiment.

In a thirteenth embodiment, the present disclosure provides a bonded article comprising the pressure-sensitive adhesive of the eleventh embodiment.

In a fourteenth embodiment, the present disclosure provides a method of making an antistatic polymer, the method comprising:
reacting a first (meth)acrylate with a second (meth)acrylate to provide a first polymer, the first polymer including divalent segments b) represented by the formula

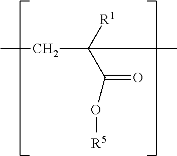

wherein
R¹ represents hydrogen or methyl, and
R⁵ represents an alkylene group having from 4 to 18 carbon atoms, inclusive, and divalent segments c) represented by the formula

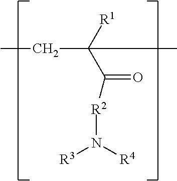

wherein
R¹ represents hydrogen or methyl,
R² represents an alkylene group having from 1 to 10 carbon atoms, inclusive, and
R³ and R⁴ independently represent alkyl groups having from 1 to 4 carbon atoms, inclusive; and
adding an initiator to the first polymer; and
reacting the first polymer with 4-(chloromethyl) styrene to provide the antistatic polymer, the antistatic polymer comprising divalent segments a) represented by the formula

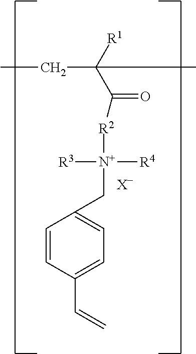

wherein
R¹ represents hydrogen or methyl,
R² represents an alkylene group having from 1 to 10 carbon atoms, inclusive,
R³ and R⁴ independently represent alkyl groups having from 1 to 4 carbon atoms, inclusive, and
X represents a chlorine.

In a fifteenth embodiment, the present disclosure provides a method according to the fourteenth embodiment, wherein R² represents an alkylene group having 2 carbon atoms.

In a sixteenth embodiment, the present disclosure provides a method according to the fourteenth or fifteenth embodiment, wherein R³ and R⁴ represent methyl.

In a seventeenth embodiment, the present disclosure provides a method according to any one of the fourteenth to sixteenth embodiments, wherein R⁵ represents an alkylene group having 8 carbon atoms.

In an eighteenth embodiment, the present disclosure provides a method according to any one of the fourteenth to seventeenth embodiments, wherein on a molar basis the ratio of divalent segment a) to the sum of divalent segments b) and c) is from 17:1 to 2.5:1, 17:1 to 3:1, or 16:1 to 4:1.

In a nineteenth embodiment, the present disclosure provides a method according to any one of the fourteenth to eighteenth embodiments, wherein on a molar basis the ratio of divalent segment a) to divalent segment c) is at least 1:1, at least 1.5:1, at least 2.3:1, at least 4:1, at least 9:1, at least 19:1, at least 32:1, at least 49:1, or at least 99:1.

In a twentieth embodiment, the present disclosure provides a method according to any one of the fourteenth to nineteenth embodiments, wherein the initiator is a photoacid generator.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

TABLE 2
Materials

| Item | Abbreviation | Source |
|---|---|---|
| 2-Ethylhexyl acrylate | 2-EHA | Millipore Sigma (St. Louis, MO) |
| 2-(Dimethylamino)ethyl | DMAEMA | Millipore Sigma (St. Louis, MO) |
| methacrylate | | |
| 4-(Chloromethyl)styrene | CMS | Millipore Sigma (St. Louis, MO) |
| Ethyl acetate | EA | Millipore Sigma (St. Louis, MO) |
| VAZO 67 | — | DuPont de Nemours, Inc., |
| | | (Wilmington, DE) |
| Isopropyl alcohol | IPA | Millipore Sigma (St. Louis, MO) |
| IRGACURE 651 | — | BASF Corporation |
| | | (Ludwigshafen, Germany) |
| (Thiophenoxyphenyl) | PAG | Gelest Inc. (Morrisville, PA) |
| diphenylsulfonium | | |
| hexafluorophosphate, | | |
| 50% in propylene | | |
| carbonate | | |
| HOSTAPHAN 3SAB | 3SAB | Mitsubishi Polyester Film, |
| | | (Greer, SC) |
| Heptane | — | Millipore Sigma (St. Louis, MO) |

### Test Methods

### 90° Angle Peel Adhesion Strength Test

Peel adhesion strength was measured at a 90° angle using an IMASS SP-200 slip/peel tester (available from IMASS, Inc., Accord Mass.) at a peel rate of 305 mm/minute (12 inches/minute) using the procedure described in ASTM International standard, D3330, Method F. Test panels were prepared by wiping the panels with a tissue wetted with the corresponding solvents shown in Table 3 using hand pressure to wipe the panel 8 to 10 times. This procedure was repeated two more times with clean tissues wetted with solvent. The cleaned panel was allowed to dry. The adhesive tape was cut into strips measuring 1.27 cm×20 cm (½ in.×8 in.) and the strips were rolled down onto the cleaned panel with a 2.0 kg (4.5 lb.) rubber roller using two passes. The prepared samples were stored at 23° C./50%RH for 24 hours before testing. Two samples were tested for each example and averaged values were expressed in Oz/inch.

TABLE 3
Peel Adhesion Test Panel Materials

| Test Panel Material | Solvent |
|---|---|
| Stainless Steel (“SS”) | Heptane |
| Soda-lime glass (“Glass”) | Heptane |

### Static Shear Strength

The static shear strength was evaluated as described in the ASTM International standard, D3654, Procedure A at 23° C./50% RH (relative humidity) using a 500 g load. Tape test samples measuring 1.27 cm×15.24 cm (½ in.×6 in.) were adhered to 1.5 inch by 2-inch stainless steel panels using the method to clean the panel and adhere the tape described in the 90° Angle Peel Adhesion Strength Test. The tape overlapped the panel by 1.27 cm×2.5 cm. and the strip was folded over itself on the adhesive side, and then folded again. A hook was hung in the second fold and secured by stapling the tape above the hook. The weight was attached to the hook and the panels were hung in a 23° C./50% RH room. The time to failure in minutes was recorded. If no failure was observed after 10000 minutes, the test was stopped and a value of >10000 minutes was recorded.

### Surface Resistivity

Surface Resistivity of pressure-sensitive adhesives (“PSAs”) was measured with a KEITHLEY 6517B High Resistance Meter (Keithley Instruments Cleveland, Ohio) with a KEITHLY 8009 Resistivity Test Fixture using ASTM D257-07 “Standard Test Methods for DC Resistance or Conductance of Insulating Materials” protocol. The upper limit of Surface Resistivity measurable by this setup is 10¹⁷ Ω/□ (i.e., ohms per square). All tests were done under ambient conditions. Adhesive samples for the measurements were prepared by the same methods as for 90° Angle Peel Adhesion Strength Test samples.

### Example 1

### Preparation of Base PSA Polymer Solutions

Base pressure-sensitive adhesive (“PSA”) copolymers were prepared by radical polymerization as follows. The monomers, EHA, and DMAEMA, were mixed with a reaction solvent, ethyl acetate, to a concentration of 35% (solid %) and thermal radical initiator (VAZO67, 0.2wt. % to total solids) in amber, narrow-necked pint bottles at room temperature. The solutions were de-aerated by purging with nitrogen gas for 5 min at room temperature. The bottles were capped tightly and put in a M228AA LAUNDER-OMETER (SDL Atlas USA, Rock Hill, S.C.) at 60° C. for 24 hours. The bottles were cooled to room temperature and the polymer solutions were used for further modifications. Detailed Base PSA Polymer formulations are summarized in Table 3.

TABLE 3
Composition of Base PSA Polymers

| Base PSA | | | 2-EHA/ | | Ethyl | |
|---|---|---|---|---|---|---|
| Polymer | 2-EHA | DMAEMA | DMAEMMA | VAZO67 | Acetate | |
| Solution | (g) | (g) | Ratio | (g) | (g) | Solid % |
| A | 43.23 | 2.28 | 95:5 | 0.09 | 84.50 | 35 |
| B | 40.95 | 4.55 | 90:10 | 0.09 | 84.50 | 35 |
| C | 38.68 | 6.83 | 85:15 | 0.09 | 84.50 | 35 |
| D | 36.40 | 9.10 | 80:20 | 0.09 | 84.50 | 35 |
| E | 34.13 | 11.38 | 75:25 | 0.09 | 84.50 | 35 |

### Example 2

### Preparation of Modified PSA Polymer Solutions

Modified PSA polymer solutions were prepared in 30 ml vials by combining base PSA polymer, 4-(chloromethyl)styrene, and IPA in amounts as shown in Table 4. The solutions were continuously stirred with magnetic stir bars at 65° C. for 6 hours. The resulting solutions were cooled and used for PSA tape coatings in Example 3.

TABLE 4
Composition for Modified PSA Polymers

| | | Base PSA | | | |
|---|---|---|---|---|---|
| Modified | Base PSA | Polymer | | | |
| PSA | Polymer | Solution | 4-(Chloromethyl) | | |
| Polymer | (35% | Amount | styrene | IPA | |
| Solution | solution) | (g) | (g) | (g) | Solid % |
| F | A | 15 | 0.26 | 3.1 | 30 |
| G | B | 15 | 0.51 | 3.7 | 30 |
| H | C | 15 | 0.77 | 4.3 | 30 |
| I | D | 15 | 1.02 | 4.9 | 30 |
| J | E | 15 | 1.28 | 5.5 | 30 |

### Example 3

### Preparation of PSA Tapes

Coating solutions for PSA tape were prepared by adding IRGACURE 651 to the base polymer solutions or the modified PSA polymer solutions in Example 1 and Example 2, respectively. Detailed compositions are summarized in Table 5.

Coated backings were prepared by solution coating a Coating Solution (see Table 5; wet gap of 8 mils) on a primed backing (3SAB). Prepared coated backings were then dried in an oven at 70° C. to evaporate the solvents. After storing the coated backings at 23° C./50%RH for 24 hours, PSA tape strips with dimensions of 1.27 cm×15.24 cm (1/2 in.×6 in.) were cut from the coated backings.

TABLE 5
Coating Solution Compositions

Coating Solution Composition

| PSA Tape | Polymer | Amount | IRGACURE 651 |
|---|---|---|---|
| Example | Solution | (solution, g) | (g) |
| C1 | A | 10 (35% solid) | 0.11 |
| C2 | B | 10 (35% solid) | 0.11 |
| C3 | C | 10 (35% solid) | 0.11 |
| C4 | D | 10 (35% solid) | 0.11 |
| C5 | E | 10 (35% solid) | 0.11 |
| Ex1 | F | 10 (30% solid) | 0.09 |
| Ex2 | G | 10 (30% solid) | 0.09 |
| Ex3 | H | 10 (30% solid) | 0.09 |
| Ex4 | I | 10 (30% solid) | 0.09 |
| Ex5 | J | 10 (30% solid) | 0.09 |

### Example 4

### PSA Tape Testing

The PSA tapes prepared in Example 3 were applied on substrates by following the methods described in the test section above. When UV cured samples were tested, UV irradiation was directly conducted on to PSA tapes which were already attached on substrates prior to measurements. The UV source used was Blacklight F15W (Osram Sylvania Inc., Danvers, Mass.) and measured dose was 1500 mJ/Cm² @UVA region. Results are shown in Table 6.

TABLE 6
Peel and Shear Properties

| | Adhesion on Glass (Oz/inch) | | Adhesion on SS (Oz/inch) | | Shear (minutes) | |
|---|---|---|---|---|---|---|
| | Before UV | After UV | Before UV | After UV | Before UV | After UV |
| PSA Tape | (average of | (average of | (average of | (average of | (average of | (average of |
| Example | 3 samples) | 3 samples) | 3 samples) | 3 samples) | 2 samples) | 2 samples) |
| C1 | 0.69 | 0.83 | — | — | <1 | <1 |
| C2 | 0.44 | 0.63 | — | — | <1 | <1 |
| C3 | 0.60 | 0.91 | — | — | <1 | <1 |
| C4 | 0.58 | 0.82 | — | — | <1 | <1 |
| C5 | 1.02 | 1.23 | — | — | <1 | <1 |
| Ex1 | 11.98 | 0.68 | 12.26 | 0.49 | 20 | >10000 |
| Ex2 | 10.59 | 0.66 | 11.7 | 0.55 | 47 | >10000 |
| Ex3 | 8.98 | 0.55 | 13.16 | 0.51 | 437 | >10000 |
| Ex4 | 0.78 | 0.52 | 0.75 | 0.51 | 2878 | >10000 |
| Ex5 | 0.45 | 0.48 | 0.33 | 0.52 | >10000 | >10000 |

As can be seen in the data of Table 6, PSA Tape Examples including compositions of the present disclosure, Ex1-Ex4, showed significant decrease in adhesion after UV irradiation due to the polymerization of the pendant unsaturation via radical polymerization. In contrast, Controls C1-C5 did not show meaningful adhesion change after UV irradiation due to the lack of polymerizable pendant unsaturation moieties. In addition, the increase in shear holding power with Ex1-Ex4 after UV irradiation indicates the system was further crosslinked and its modulus was increased. With respect to Ex5, while not wishing to be bound to a particular theory, it is believed that the quaternary ammonium salt can act as an ionic crosslink in this system and may affect various PSA properties such as modulus, adhesion, and shear properties. Thus, Ex5, which has the highest level of the grafted 4-(chloromethyl)styrene unit of the tested formulations, has an initial quaternary ammomium salt amount that is above a threshold for a preferred PSA (e.g., it is too stiff, has low adhesion but high shear strength before UV irradiation). After UV irradiation, the UV triggered crosslinking via styrene unit did not change the properties of Ex5 significantly since it was already quite stiff before UV irradiation.

### Example 5

### Preparation of PSA Tapes

Coating solutions for PSA tape were prepared by adding photoacid generator to the modified PSA polymer solutions of Example 2. Detailed compositions are summarized in table 7. PSA Tapes Ex 6-Ex10 include a photoacid generator (“PAG”; (Thiophenoxyphenyl) diphenylsulfonium hexafluorophosphate) instead of IRGACURE 651 to demonstrate the crosslinkability of the grafted styrenic moieties by the cationic route.

Coated backings were prepared by solution coating a Coating Solution (see Table 7; wet gap of 8 mils) on a primed backing (3SAB). Prepared coated backings were then dried in an oven at 70° C. to evaporate the solvents. After storing the coated backings at 23° C./50%RH for 24 hours, PSA tape strips with dimensions of 1.27 cm×15.24 cm (½ in.×6 in.) were cut from the coated backings.

TABLE 7
Coating Solution Compositions

Coating Solution Composition

| PSA Tape | Modified PSA | Amount | PAG |
|---|---|---|---|
| Example | Polymer Solution | (solution, g) | (g) |
| Ex 6 | F | 10 (30% solid) | 0.18 |
| Ex 7 | G | 10 (30% solid) | 0.18 |
| Ex 8 | H | 10 (30% solid) | 0.18 |
| Ex 9 | I | 10 (30% solid) | 0.18 |
| Ex10 | J | 10 (30% solid) | 0.18 |

### Example 6

### PSA Tape Testing

The PSA tapes prepared in Example 5 were applied on substrates by following the methods described in the test section above. When UV cured samples were tested, UV irradiation was directly conducted on to PSA tapes which were already attached on substrates prior to measurements. The UV source used was Blacklight F15W (Sylvania) and measured dose was 1500 mJ/Cm² @UVA region. Results are shown in Table 8.

TABLE 8
Peel and Shear Properties

| | Adhesion on Glass (Oz/inch) | | Adhesion on SS (Oz/inch) | | Shear (minutes) | |
|---|---|---|---|---|---|---|
| | Before UV | After UV | Before UV | After UV | Before UV | After UV |
| PSA Tape | (average of | (average of | (average of | (average of | (average of | (average of |
| Example | 3 samples) | 3 samples) | 3 samples) | 3 samples) | 2 samples) | 2 samples) |
| Ex 6 | 12.21 | 4.80 | 12.45 | 0.27 | 23 | 68 |
| Ex 7 | 10.43 | 7.26 | 11.63 | 8.68 | 50 | 155 |
| Ex 8 | 9.51 | 3.47 | 13.51 | 11.77 | 440 | >10000 |
| Ex 9 | 0.77 | 0.68 | 0.78 | 1.88 | 2877 | >10000 |
| Ex 10 | 0.45 | 0.47 | 0.33 | 0.67 | >10000 | >10000 |

The data in Table 8 show that the unsaturation moiety in PSAs of this Example (i.e., a styrenic double bond, not a (meth)acrylate double bond) can also be polymerizable by cationic routes while most (meth)acrylate are not. By having a photoacid generator(“PAG”) instead of radical initiator, the formulations of Ex6-Ex9 demonstrated adhesion decrease as well as shear holding power increase after UV irradiation.

### Example 7

### Surface Resistivity

Surface resistivity was tested as described above. Results are shown in Table 9.

TABLE 9
Surface Resistivity

| | Polymer | Surface Resistivity | |
|---|---|---|---|
| Example | Solution | (Ω/□) | Comments |
| C6 | A | 4.29E+14 | Control, no ionic group |
| Ex11 | F | 2.21E+13 | Least amount of |
| | | | ammonium salt |
| Ex12 | G | 1.60E+12 | |
| Ex13 | H | 2.95E+11 | |
| Ex14 | I | 1.35E+10 | |
| Ex15 | J | 7.50E+09 | Greatest amount of |
| | | | ammonium salt |

As can be seen in the data of Table 9, surface resistivities of PSAs Ex 11-Ex 15 (i.e., PSAs containing quaternary ammonium salt) showed significantly lower resistivity than the control (without ionic cluster) suggesting that these inventive materials can be used for anti-static applications. It was also revealed that the resistivity directly depends on the amount of ammonium salt in the system, e.g., Ex 11 with low salt showed a higher resistivity than Ex 15 with a higher salt content.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. An antistatic polymer comprising:
divalent segments a) represented by the formula 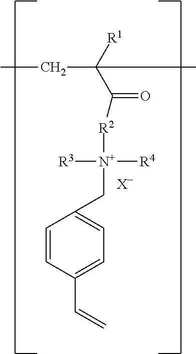
wherein
R¹represents hydrogen or methyl,
R² represents an alkylene group having from 1 to 10 carbon atoms, inclusive,
R³ and R⁴ independently represent alkyl groups having from 1 to 4 carbon atoms, inclusive, and
X represents a halogen.

2. The antistatic polymer of claim 1, further comprising divalent segments b) represented by the formula 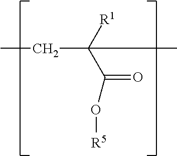
wherein
R¹ represents hydrogen or methyl, and
R⁵ represents an alkylene group having from 4 to 18 carbon atoms, inclusive.

3. The antistatic polymer of claim 1, further comprising divalent segments c) represented by the formula 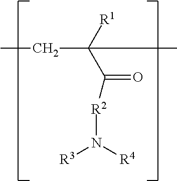
wherein
R¹ represents hydrogen or methyl,
R² represents an alkylene group having from 1 to 10 carbon atoms, inclusive, and
R³ and R⁴ independently represent alkyl groups having from 1 to 4 carbon atoms, inclusive.

4. The antistatic polymer of claim 1, wherein R² represents an alkylene group having 2 carbon atoms.

5. The antistatic polymer of claim 1, wherein R³ and R⁴ represent methyl.

6. The antistatic polymer of claim 1, wherein R⁵ represents an alkylene group having 8 carbon atoms.

7. The antistatic polymer of claim 1, wherein on a molar basis the ratio of divalent segment a) to the sum of divalent segments b) and c) is from 17:1 to 2.5:1, 17:1 to 3:1, or 16:1 to 4:1.

8. The antistatic polymer of claim 1, wherein on a molar basis the ratio of divalent segment a) to divalent segment c) is at least 1:1, at least 1.5:1, at least 2.3:1, at least 4:1, at least 9:1, at least 19:1, at least 32:1, at least 49:1, or at least 99:1.

9. The antistatic polymer of claim 1, wherein the antistatic polymer has a Surface Resistivity of less than 1×10¹⁴ Ω/□.

10. The polymer of claim 1, wherein the antistatic polymer exhibits lower adhesion to a surface after exposure to ultra-violet light.

11. The antistatic polymer of claim 1, wherein the antistatic polymer is a pressure-sensitive adhesive.

12. An adhesive tape comprising the pressure-sensitive adhesive of claim 11.

13. A bonded article comprising the pressure-sensitive adhesive of claim 11.

14. A method of making an antistatic polymer, the method comprising:
reacting a first (meth)acrylate with a second (meth)acrylate to provide a first polymer, the first polymer including divalent segments b) represented by the formula 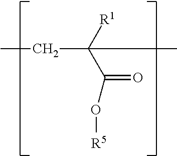
wherein
R¹ represents hydrogen or methyl, and
R⁵ represents an alkylene group having from 4 to 18 carbon atoms, inclusive, and divalent segments c) represented by the formula 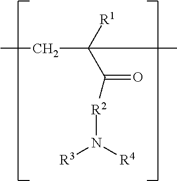
wherein
R¹ represents hydrogen or methyl,
R² represents an alkylene group having from 1 to 10 carbon atoms, inclusive, and
R³ and R⁴ independently represent alkyl groups having from 1 to 4 carbon atoms, inclusive; and
adding an initiator to the first polymer; and
reacting the first polymer with 4-(chloromethyl) styrene to provide the antistatic polymer, the antistatic polymer comprising divalent segments a) represented by the formula 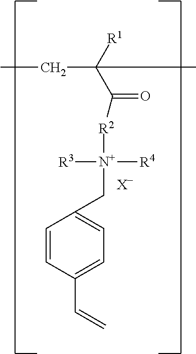
wherein
R¹ represents hydrogen or methyl,
R² represents an alkylene group having from 1 to 10 carbon atoms, inclusive,
R³ and R⁴ independently represent alkyl groups having from 1 to 4 carbon atoms, inclusive, and
X represents a chlorine.

15. The method of claim 14, wherein R² represents an alkylene group having 2 carbon atoms.

16. The method of claim 14, wherein R³ and R⁴ represent methyl.

17. The method of claim 14, wherein R⁵ represents an alkylene group having 8 carbon atoms.

18. The method of claim 14, wherein on a molar basis the ratio of divalent segment a) to the sum of divalent segments b) and c) is from 17:1 to 2.5:1, 17:1 to 3:1, or 16:1 to 4:1.

19. The method of claim 14, wherein on a molar basis the ratio of divalent segment a) to divalent segment c) is at least 1:1, at least 1.5:1, at least 2.3:1, at least 4:1, at least 9:1, at least 19:1, at least 32:1, at least 49:1, or at least 99:1.

20. The method of claim 14, wherein the initiator is a photoacid generator.
